(19) United States
(12) Patent Application Publication
(10) Pub. No.: US 2012/0002283 A1
(43) Pub. Date: Jan. 5, 2012

(54) METHOD AND APPARATUS FOR RAMAN CO-PUMPS

(76) Inventors: Chongjin Xie, Morganville, NJ (US); Chandrasekhar Sethumadhavan, Old Bridge, NJ (US); Robert William Tkach, Little Silver, NJ (US)

(21) Appl. No.: 12/828,229

(22) Filed: Jun. 30, 2010

(51) Int. Cl. G02B 27/10; G02B 27/28; H01S 3/13

(52) U.S. Cl. 359/492.01; 372/20; 359/618; 359/494.01

(57) ABSTRACT

An example Raman co-pump apparatus includes a control module for controlling output received from at least one of a first laser and a second laser, said output of said first laser and said second laser for combining into a co-pump output, wherein the control module is configured to increase a frequency difference between said first laser and said second laser. The apparatus may also include at least one of a first laser for providing a first output, a second laser for providing a second output and a polarization beam combiner for combining the first and second output into the co-pump output. Spectral overlap of orthogonally polarized pump lasers is avoided via: 1) control of the frequency (wavelength) interleave and the mode spacing of co-pump lasers; 2) control of frequency (wavelength) offset of co-pump lasers to reduce spectral overlap; and 3) use a single co-pump laser with large mode spacing.

### TECHNICAL FIELD

This invention relates to optical communications, and more particularly, to Raman co-propagating pumps (hereafter referred to as co-pumps) for optical coherent communications systems.

### BACKGROUND OF THE INVENTION

Bidirectional Raman amplification, which uses both Raman co-pumps and counter-propagating pumps (hereafter called counter-pumps) together, is one of the key technologies for long haul high-speed fiber optic transmission systems. Compared with only counter-pumps, the addition of co-pumps brings many benefits to a system: 1) reduced launch power for the signal; 2) better optical signal to signal ratio (OSNR) or equivalently less fiber nonlinear effect; 3) flattening of Raman gain and noise figure over a wide bandwidth; and 4) reduced requirement on counter-pump power due to the forward Raman gain provided by Raman co-pumps.

In order to reduce polarization dependent gain (PDG) and suppress Stimulated Brillouin Scattering (SBS), Raman co-pumps are typically composed of two lasers that are polarization multiplexed together by a polarization beam combiner (PBC), where each laser, in general, is a multi-mode laser, such as Fabry-Perot multi-mode laser and inner-grating multi-mode laser.

Raman co-pumps have been successfully deployed in long-haul on-off-keying (OOK) and differential-phase-shift-keying (DPSK) systems using direct detection.

### SUMMARY OF THE INVENTION

Recently, the inventors discovered that the Raman co-pumps could cause a large penalty in a polarization-division-multiplexed (PDM) optical transmission system that uses coherent reception aided by digital signal processing (hereafter called optical coherent system) and severely degrade the system performance. This implies that one may not be able to use Raman co-pumps in high speed optical coherent systems or that the existing deployed systems with Raman co-pumps may not be upgraded to optical coherent systems. Embodiments according to the principles of the invention address this Raman co-pump problem in PDM coherent systems.

One example of a Raman co-pump apparatus according to the principles of the invention includes a control module for controlling output received from at least one of a first laser and a second laser, said output of said first laser and said second laser for combining into a co-pump output, wherein the control module is configured to increase a mode frequency difference between said first laser and said second laser. The apparatus may also include at least one of a first laser for providing a first output, a second laser for providing a second output and a polarization beam combiner for combining the first and second output into the co-pump output. In other example apparatuses, spectral overlap of orthogonally polarized pump lasers is avoided via: 1) control of the frequency (wavelength) interleave and the mode spacing of co-pump lasers; 2) control of frequency (wavelength) offset of co-pump lasers to reduce spectral overlap; and 3) use a single co-pump laser with large mode spacing.

### BRIEF DESCRIPTION OF THE DRAWING

FIG. 1 shows a first example embodiment of a Raman co-pump according to the principles of the invention;

FIG. 2 shows a second example embodiment of a Raman co-pump according to the principles of the invention;

FIG. 3 shows an illustration of the spectrum of a example Raman co-pump according to the principles of the invention;

FIG. 4 shows a third example embodiment of a Raman co-pump according to the principles of the invention; and

FIG. 5 shows a fourth example embodiment of a Raman co-pump according to the principles of the invention;

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

Additionally, unless otherwise explicitly specified herein, any lens shown and/or described herein is actually an optical system having the particular specified properties of that lens. Such an optical system may be implemented by a single lens element but is not necessarily limited thereto. Furthermore, as is well known in the art, the functionality of a curved mirror may be realized via a combination of lenses and minors and vice versa. Moreover, any arrangement of optical components that are performing a specified function, e.g., an imaging system, gratings, coated elements, and prisms, may be replaced by any other arrangement of optical components that perform the same specified function. Thus, unless otherwise explicitly specified here, all optical elements or systems that are capable of providing specific function within an overall embodiment disclosed herein are equivalent to one another for purposes of the present disclosure.

It will be understood that, although the terms first second, etc. may be used herein to describe various elements, these elements should not be limited by these terms since such terms are used only to distinguish one element from another. For example, a first element could be termed a second element, and similarly, a second element could be termed a first element, without departing from the scope of example embodiments. In the description, identically numbered components within different ones of the FIGs. refer to the same components.

Raman co-pump penalties on polarization-division-multiplexed optical coherent systems are caused by polarization dependent cross phase modulation (XPM) and nonlinear polarization rotation induced signal depolarization. When the outputs of two co-pump lasers are combined together by a PBC, the effective polarization of the co-pumps changes along the transmission line. The polarization change of Raman co-pumps cause the nonlinear polarization scattering in the signal, which induces crosstalk between two polarizations of the polarization-division-multiplexed signal. The larger the frequency difference between the two lasers, the faster this polarization change of the co-pumps in the transmission line. Fast changes of the polarization average out the polarization dependent XPM and nonlinear polarization rotation, and therefore can reduce the Raman co-pump penalties.

Accordingly, example embodiments according to the principles of the invention utilize one or more of the following techniques to increase the frequency difference between the two lasers of a co-pump and thus reduce/eliminate the Raman co-pump penalties in an optical coherent system. Example embodiments are configured to avoid the spectral overlap of orthogonally polarized pump lasers by: 1) frequency (wavelength) interleaving the two co-pump lasers and increasing mode spacing of the two lasers; 2) frequency (wavelength) offset the two lasers to reduce spectral overlap between the two lasers, and depolarize each laser with a depolarizer; 3) use a single depolarized co-pump laser with large mode spacing.

FIG. 1 shows a first example embodiment of a Raman co-pump apparatus 100 according to the principles of the invention. Two co-pump lasers 110, 120 are polarization multiplexed together by a polarization beam combiner (PBC) 130. The first laser 110 and the second laser may be temperature controlled. In one embodiment, the first and second lasers are orthogonally polarized pump lasers. For example, the lasers may be multi-mode lasers, such as Fabry-Perot multi-mode lasers and inner-grating multi-mode lasers. The PBC combines the output of first laser and the second laser for into a co-pump output 190.

Control module 140 controls at least one of the first and second lasers in order to control output received from at least one of a first laser and a second laser. The control module may be configured to increase a mode frequency difference between the first laser and the second laser. The control module also may be configured to minimize spectral overlap of the first and second lasers. In another embodiment, the control module is configured to adjust a wavelength of the first laser, the second laser or both lasers in order that the wavelengths of the first and the second lasers are interleaved. In a further embodiment, the wavelength of each mode of one the first laser and the second laser is adjusted by the control module to be approximately in the middle of two modes of the other of the first and second laser.

In one embodiment, the control module may control the temperature of one or more of the two lasers to adjust wavelength. The adjustment of temperature may be based on a lookup table that is initially provisioned according to the result of a testing procedure. Accordingly, in such an embodiment, the lasers are temperature controlled.

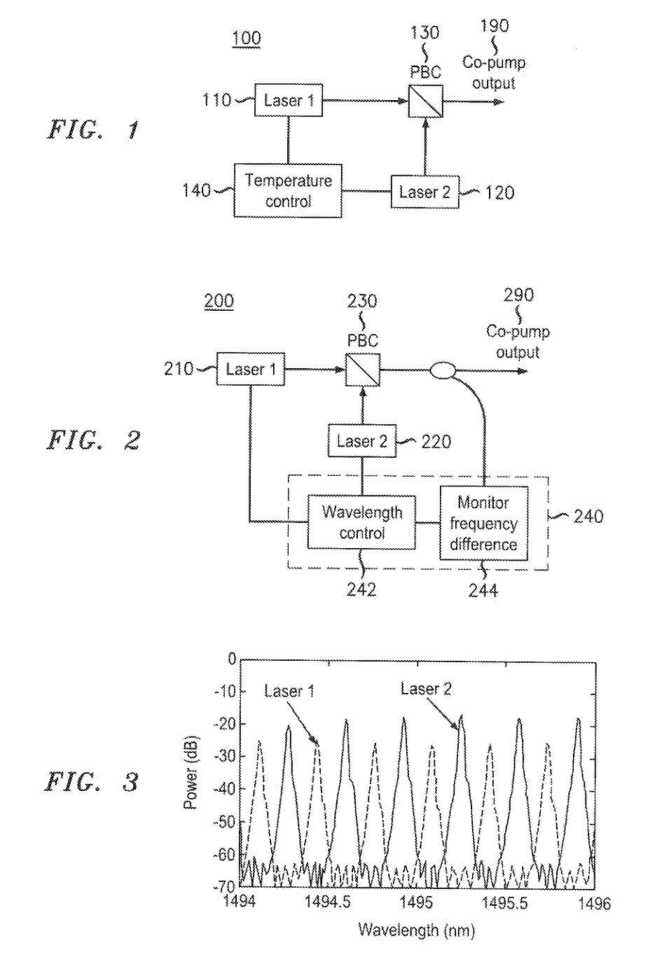

FIG. 2 shows a second example embodiment of a Raman co-pump according to the principles of the invention. Two co-pump lasers 210, 220 are polarization multiplexed together by a PBC 230. Control module 240 includes a frequency difference monitor 244 and a wavelength control module 242. The Frequency difference monitors a frequency difference between said first laser and said second laser based on the co-pump output 290. At the output of the PBC, a portion of the co-pump output is tapped and fed into a frequency difference. The wavelength control module adjusts a wavelength of at least one of the first and second laser based on the monitored frequency difference. In one embodiment, the control module 240 is adapted to frequency (wavelength) interleave the first and second laser, and increase the mode spacing of the first and second lasers.

FIG. 3 shows an illustration of the spectrum of an example Raman co-pump according to the principles of the invention. As mentioned above, the wavelength of the two lasers may be controlled and set in such a way that their wavelengths are interleaved. As shown in FIG. 3, the wavelength of the lasers can be controlled such that the wavelength of each mode of one laser is about in the middle of two modes of the other laser.

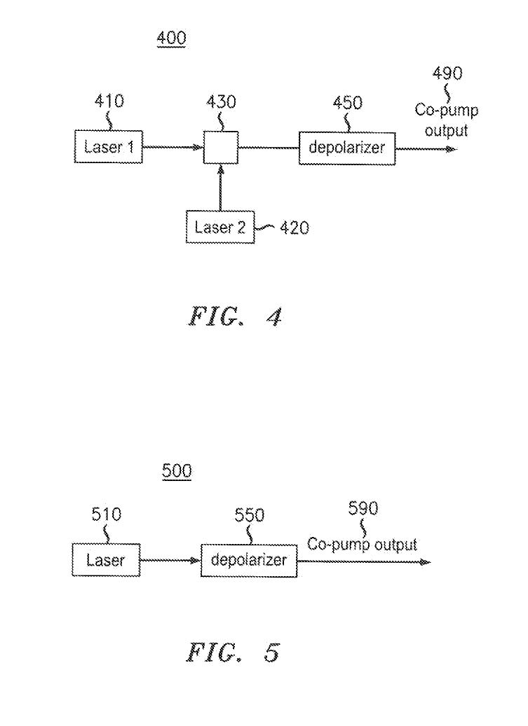

FIG. 4 shows a third example embodiment of a Raman co-pump according to the principles of the invention. Two co-pump lasers 410, 420 are combined by a combiner 430. The combiner can be a polarization beam combiner (PBC) or an ordinary power combiner such as a 3-dB coupler. There is a wavelength offset between the two co-pump lasers so that there is no substantial overlap between the spectra of the two lasers. In this context, by no substantial overlap between spectra of the first and second lasers is meant a wavelength offset such that there is no more than approximately 20-30% overlap.

Accordingly, the combiner is configured to combine output received from the first laser and second laser into a co-pump output, wherein the output received from said first laser is frequency (wavelength) offset from the output received from said second laser to reduce spectral overlap.

At the output of the combiner, a depolarizer is used to depolarize each laser to reduce the polarization dependent gain (PDG). The depolarizer is optional if a PBC is used to combine the two lasers. The depolarizer may be a piece of polarization maintaining fiber (PMF) or a cascade of a few pieces of PMF. In other embodiments, a depolarizer may also be positioned after each laser and before the combiner. In one embodiment, the first and second lasers are a single depolarized co-pump laser with large mode spacing. For example, the lasers may be offset by approximately 9-10 GHz.

FIG. 5 shows a fourth example embodiment of a Raman co-pump according to the principles of the invention. This fourth embodiment utilizes a single laser with a depolarizer to achieve the desired wavelength offset.

What is claimed is:

1. An apparatus comprising:
a control module for controlling output received from at least one of a first laser and a second laser, said output of said first laser and said second laser for combining into a co-pump output, wherein the control module is configured to increase a frequency difference between said first laser and said second laser.

2. The apparatus of claim 1 further comprising:
at least one of said first laser for providing a first output and said second laser for providing a second output.

3. The apparatus of claim 1 further comprising:
a polarization beam combiner for combining the output received from said first laser and said second laser into the co-pump output.

4. The apparatus of claim 1 wherein the control module is configured to minimize spectral overlap of said first laser and said second laser, wherein said first and second lasers are orthogonally polarized pump lasers.

5. The apparatus of claim 1 wherein the control module is configured to adjust a wavelength of at least one of said first laser and said second laser such that the wavelengths of the first and the second lasers are interleaved.

6. The apparatus of claim 5 wherein the control module is configured to adjust the wavelength of each mode of one of said first laser and said second laser to be approximately in the middle of two modes of the other of said first and second laser.

7. The apparatus of claim 1 wherein at least one of said first laser and said second laser is temperature controlled.

8. The apparatus of claim 7 wherein the control module is configured to adjust a temperature of at least one of said first laser and said second laser.

9. The apparatus of claim 8 wherein the control module is configured to adjust the temperature based on a lookup table.

10. The apparatus of claim 1 wherein the control module is configured to
monitor a frequency difference between said first laser and said second laser based on the co-pump output, and
adjust a wavelength of at least one of said first laser and said second laser based on the monitored frequency difference.

11. The apparatus of claim 1 wherein the control module is configured to
frequency interleave said first laser and said second laser, and
increase mode spacing of said first and second lasers.

12. An apparatus comprising:
a combiner for combining output received from a first laser and a second laser into a co-pump output, wherein the output received from said first laser is frequency offset from the output received from said second laser to reduce spectral overlap.

13. The apparatus of claim 12 further comprising:
at least one of a first laser for providing a first output and a second laser for providing a second output.

14. The apparatus of claim 12 further comprising:
a depolarizer for depolarizing at least one of the output received from the first output, the output received from the second output and the co-pump output.

15. The apparatus of claim 14 wherein the depolarizer comprises:
at least one piece of polarization maintaining fiber (PMF).

16. The apparatus of claim 12 wherein a wavelength offset between the output received from said first and second lasers is such that there is no substantial overlap between spectra of the first and second lasers.

17. The apparatus of claim 1 wherein the first and second lasers are a single depolarized co-pump laser with large mode spacing.

18. A method comprising:
controlling output of at least one of a first laser and a second laser to increase the frequency difference between said first laser and said second laser, said output of said first laser and said second laser for combining into a co-pump output.

19. The method of claim 18 further comprising:
combining the output of said first laser and said second laser into the co-pump output.

20. The method of claim 18 wherein controlling the output comprises:
minimizing spectral overlap of said first and second lasers, wherein said first and second lasers are orthogonally polarized pump lasers.

21. The method of claim 18 wherein controlling the output comprises:
adjusting a wavelength of at least one of said first and the second lasers such that the wavelengths of said first and the second lasers are interleaved.

22. The method of claim 18 wherein controlling the output comprises:
adjusting the wavelength of each mode of one of said first and second laser to be approximately in the middle of two modes of the other of said first and second laser.

23. The method of claim 18 wherein controlling the output comprises:
controlling temperature of at least one of said first and second lasers.

24. The method of claim 18 wherein controlling the output comprises:
monitoring a frequency difference between said first and second lasers based on the co-pump output, and
adjusting a wavelength of at least one of said first and second lasers based on the monitored frequency difference.

25. The method of claim 18 wherein controlling the output comprises:
frequency interleaving said first laser and said second laser, and
increasing mode spacing of said first and second lasers.
